(19) United States
(12) Patent Application Publication
(10) Pub. No.: US 2011/0091760 A1
(43) Pub. Date: Apr. 21, 2011

(54) System and Method for Inhibiting the Propagation of an Exothermic Event

(75) Inventors: Jeffrey B. Straubel, Menlo Park, CA (US); David Lyons, Palo Alto, CA (US); Eugene Berdichevsky, Palo Alto, CA (US); Scott Kohn, Menlo Park, CA (US); Ryan Teixeira, Dublin, CA (US)

(73) Assignee: TESLA MOTORS, INC., Palo Alto, CA (US)

(21) Appl. No.: 12/981,912

(22) Filed: Dec. 30, 2010

Related U.S. Application Data
(63) Continuation of application No. 11/444,572, filed on May 31, 2006.
Application No. 11/444,572 is a continuation-in-part of application No. 11/129,118, filed on May 12, 2005, now abandoned.

(51) Int. Cl. H01M 10/50; F28D 15/00

(52) U.S. Cl. 429/120; 165/104.31

(57) ABSTRACT

A system and method disperses a sudden increase in heat generated by one battery cell to a large area including multiple battery cells, thereby preventing the sudden increase from being absorbed primarily by a small number of other battery cells, such as a single battery cell, that could otherwise cause the other battery cells to fail or release their own heat.

### CROSS-REFERENCE TO RELATED APPLICATION

This application is a continuation of U.S. patent application Ser. No. 11/444,572, filed May 31, 2006, which is a continuation-in-part of U.S. patent application Ser. No. 11/129,118, filed May 12, 2005 the disclosures of which are incorporated herein by reference for any and all purposes.

### FIELD OF THE INVENTION

The present invention is related to energy conservation and more specifically to electric or hybrid vehicle power systems.

### BACKGROUND OF THE INVENTION

Conventional rechargeable battery cells are subject to an occasional rapid increase in, and release of, heat due to various factors. The increase and release of heat may occur due to an external cause, such as a short circuit applied to the battery cell terminals, or it may be due to an internal defect. When a battery cell experiences such a rapid increase in heat, the vent in the cap of the battery cell will open, frequently in allocation designed to act that way in the presence of rapidly increasing heat, releasing the heat and gases from the battery cell. The increase in heat and the failure may be as significant as something that acts like a roman candle, or the increase in heat and failure may exhibit other characteristics, all of which seriously degrade the battery cell, up to the point of complete failure. In any event, heat is released from the battery cell to its surroundings.

Although such rapid increases and releases of heat may be relatively rare, if the release in heat occurs in a bank of battery cells, the release of heat may be sufficient to cause other surrounding battery cells to thermally react if the heat absorbed from the first battery cell causes any of the adjacent battery cells to rise above a thermal runaway point. At that point, a sustaining thermal reaction occurs that causes the battery cell or battery cells above their thermal runaway points to generate and release their own heat, resulting in a failure and possible venting in a similar way.

Such a thermal runaway reaction can continue from one battery cell to the next as a chain reaction, with the potential to generate significant amounts of heat in a bank of many battery cells. It is possible to spread the battery cells apart sufficiently from one another in all dimensions to prevent an initial increase and release of heat from initiating such a chain reaction. This is because the heat from the first failing battery cell or cells will dissipate in the air sufficiently prior to reaching nearby battery cells or cells, so that the heat provided to the other battery cells or cells will not rise to the level required to start such a chain reaction. However, such an arrangement can increase the space required to house the battery cells, or reduce the power that can be supplied by the battery cells in the space available.

Many conventional battery cells are electrically connected to at least part of the case of the battery cell, making any alternative solution subject to the requirement that the solution not electrically connect the terminals of a battery cell to one another or to another battery with which electrical isolation is desired.

What is needed is a system and method that can reduce the likelihood that an initial sudden release of heat from a battery cell will start a chain reaction in one or more other battery cells, without requiring that the battery cells be spread far apart to prevent any such chain reaction.

### SUMMARY OF THE INVENTION

In at least one other embodiment of the invention, a battery pack is provided that is comprised of (i) a plurality of cells arranged into at least a first row of cells and a second row of cells, wherein the first row of cells is adjacent to the second row of cells, wherein the first row of cells is offset from the second row of cells, and wherein each of the plurality of cells includes a cell case; (ii) at least one cooling tube containing a liquid coolant, wherein the at least one cooling tube is interposed between the first and second cell rows; and (iii) a thermally conductive material that at least partially surrounds and contacts each cell case as well as the cooling tube. The at least one cooling tube may be comprised of at least two cooling tubes, wherein the liquid coolant in one of the cooling tubes flows past each cell in a first direction and the liquid coolant in the second of the cooling tubes flows past each cell in a second, opposite direction. The cells may be cylindrically shaped. The thermally conductive material may surround and contact between 5% and 30% of the height of each cell. The thermally conductive material may initially comprise a liquid that is poured around the cells and over the cooling tube and which then solidifies to a completely solid, or semi-solid, state. The thermally conductive material surrounding a cell undergoing a thermal event (e.g., thermal runaway) may change phase from a solid to a liquid. The thermally conductive material may be electrically insulating. The spacing between adjacent cells may be less than or equal to half the cell width. The center-to-center spacing between adjacent cells may be less than or equal to twice the cell diameter.

In at least one other embodiment of the invention, a method of dispersing heat from a thermal event occurring within at least one cell of a plurality of cells is provided, the method including the steps of (i) surrounding and contacting at least a portion (for example, between 5% and 30%) of the cell case of each cell of the plurality of cells with a thermally conductive material; (ii) contacting at least one cooling tube containing a liquid coolant with the thermally conductive material; (iii) pumping the liquid coolant through the cooling tube, wherein heat from the thermal event is transferred via the thermally conductive material to adjacent cells and to said liquid coolant. The method may further include the steps of arranging the plurality of cells into at least a first row of cells and a second row of cells, wherein the first row of cells is adjacent to, and offset from, the second row of cells, and wherein the cooling tube is positioned between the first and second rows of cells. The step of surrounding and contacting the cells may further include the step of pouring the thermally conductive material around the cells and the cooling tube, wherein the thermally conductive material solidifies after application. The thermally conductive material may be electrically insulating. The portion of the thermally conductive material surrounding the cell undergoing the thermal event may change phase from a solid phase to a liquid phase. The method may further include the step of positioning the cells such that the spacing between adjacent cells is less than or equal to half the cell width. The method may further include the step of positioning the cells such that the center-to-center spacing between adjacent cells is less than or equal to twice the cell diameter.

A further understanding of the nature and advantages of the present invention may be realized by reference to the remaining portions of the specification and the drawings.

### BRIEF DESCRIPTION OF THE DRAWINGS

FIG. 1A is a diagram of a system of battery cells inhibited from thermal chain-reactions according to one embodiment of the present invention;

FIG. 1B is a side view of two of the rows of battery cells in the system of FIG. 1A according to one embodiment of the present invention;

FIG. 1C is a side view of battery cells at least partly surrounded by a thermally-conductive sheet according to one embodiment of the present invention;

FIG. 1D is an overhead view of battery cells at least partly surrounded by a thermally-conductive sheet according to one embodiment of the present invention;

FIG. 2 is a flowchart illustrating a method of manufacturing a chain-reaction-inhibiting battery cell pack and distributing heat generated from one battery cell to several battery cells according to one embodiment of the present invention; and

FIG. 3 is a diagram of a conventional vehicle with the battery cell assembly of the present invention.

### DESCRIPTION OF THE SPECIFIC EMBODIMENTS

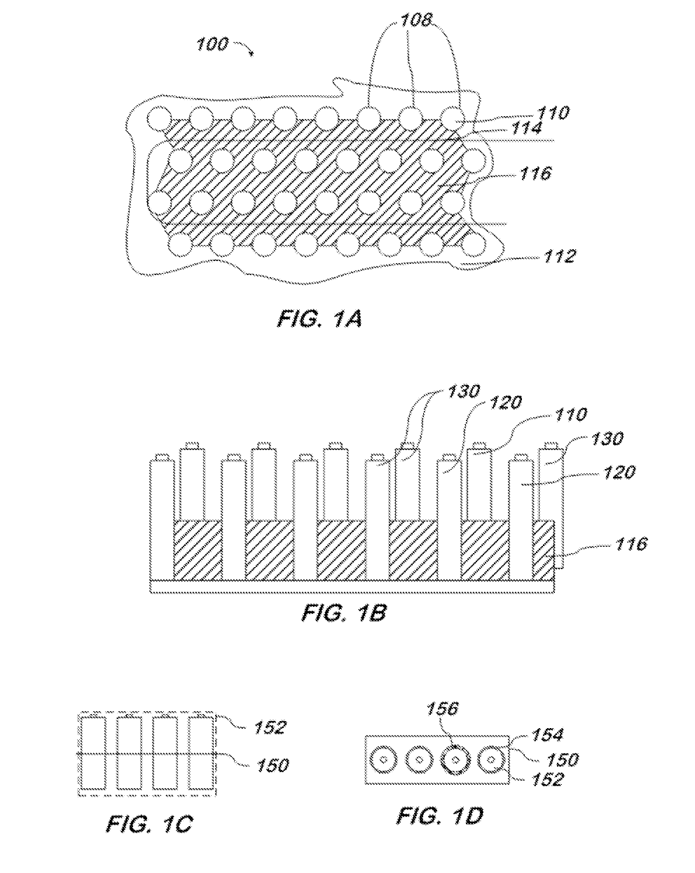

Referring now to FIG. 1A, a system of battery cells inhibited from thermal chain reactions is shown according to one embodiment of the present invention. The system of more than one battery cell is referred to as a “battery cell pack” or “battery cell assembly”, which mean the same thing as used herein and is one form of an “electrical storage pack”. In one embodiment, the battery cells 108 have a substantially cylindrical shape, though any form factor used for storing energy may be used, such as prismatic cells. The battery cells 108 may be any type of energy storage device, including high energy density, high power density, such as nickel-metal-hydride or nickel-cadmium, nickel-zinc, air-electrode, silver-zinc, or lithium-ion energy battery cells. Battery cells may be of any size, including mostly cylindrical 18×65 mm (18650), 26×65 mm (26650), 26×70 mm (26700), prismatic sizes of 34×50×10 mm, 34×50×5.2 mm or any other size/form factor. Capacitors may also be used, such as supercaps, ultracaps, and capacitor banks may be used in addition to, or in place of, the battery cells. As used herein, an “electrical storage pack” includes any set of two or more devices that are physically attached to one another, capable of accepting and storing a charge, including a battery cell or a capacitor, that can fail and release heat in sufficient quantity to cause one or more other nearby devices capable of accepting and storing a charge, to fail. Such devices are referred to herein as “power storage devices”.

The battery cells 108, such as battery cell 110, in the assembly 100 are mounted in one or more substrates, such as substrate 112, as described in the related application. There may be any number of battery cells 108 in the assembly 100. Although only three battery cells 108 are referenced in the figure to avoid cluttering it, all of the circles are intended to be referenced by 108. The battery cells 108 are located nearby one another, for example not more than 20 mm center-to-center distance for battery cells 108 that have a maximum diameter of 18 mm. Other embodiments have spacing under one quarter or one half of the center to center distance, making the spacing between the battery cells less than half the width of the battery cell in the plane that spans the center of each pair of battery cells. In one embodiment, the center-to-center distance for the battery cells 108 (measured from the center of a battery cell to the center of its nearest neighbor) does not exceed twice the maximum diameter of the battery cells, although other multiples may be used and the multiples need not be whole numbers. Not all of the battery cells 108 in the system need be spaced as closely, but it can be helpful to space the battery cells relatively closely, while providing adequate space to ensure the thermally-conductive material, described below, has room to be added.

In one embodiment, the substrate 112 is that described in the related application. Briefly, the substrate 112 is a substrate sheet containing holes that are surrounded by mounting structures that hold the battery cells firmly against the substrate, positioned with the terminals of the battery cells 108 over the holes, with each of the battery cells 108 located between two of the substrates. Different substrates such as substrate 112 are located at either end of each of the battery cells and the different substrates in which each battery cell is mounted are located approximately one battery cell length apart from one another (only one substrate is shown in the figure, but another one would be pressed onto the tops of battery cells 108. The radiuses of the holes are equal to or smaller than the radius of the battery cells 108 at the hole.

The battery cell mounting process involves inserting the battery cells 108 into one or more substrates 112 at one side, such as the bottom. Cooling tubes 114 are added adjacent to each of the battery cells 108 as described in the related application and carry a coolant to absorb and conduct heat, though it is noted that the coolant in the cooling tubes 114 may not be a significant thermal conductor relative to the potting compound described below.

A thermally-conductive material such as thermally-conductive potting compound or another thermally-conductive material 116 is poured or placed around the battery cells 108 so that the battery cells having 65 mm height are standing in the potting compound or other thermally-conductive material 116 at least to a depth of approximately 6 mm that will cover a part of the battery cells and the cooling tubes. Other embodiments may employ other depths, which may be approximately 5%, 15%, 20%, 25%, or 30% of the height of the battery cell.

In one embodiment, the conventional Stycast 2850 kt, commercially available from Emmerson and Cuming Chemical Company of Billerica, Mass. (Web site: emmersoncuming.com) is used as the potting compound 116, though any potting compound or other material with a high thermal conductivity can be used. The Stycast catalyst CAT23LV is used with the potting compound.

It is not necessary that the thermally conductive material quickly release heat to the nearby battery cells or the ambient air. In one embodiment, the thermally conductive material absorbs more than a nominal amount of heat. For example, in one embodiment, the thermally conductive material is selected so that at least some of the thermally-conductive material nearby a battery cell that is experiencing a failure will undergo a phase change, for example, from a solid to a liquid or from a liquid to a gas. For example, the thermally-conductive material may contain a material that will undergo such a phase change and that is micro-encapsulated in the thermally conductive material, allowing the thermally-conductive material to more rapidly absorb additional heat. The heat may therefore be dispersed to the nearby battery cells and the ambient air over time, causing the adjacent battery cells to absorb less heat and to do so more gradually.

The thermal conductivity of the thermally conductive material 116 poured or placed around the battery cells 108 should be high enough to absorb the heat generated from any battery cell (for example, battery cell 110) that is venting gases in a worst case scenario and absorb it or distribute it to the air and to many of the battery cells 108, including those nearest to the battery cell 110 generating the heat as well as others farther away from the nearest battery cells, without allowing any of the battery cells to which heat is being distributed to reach a temperature that would cause a self-sustaining reaction that would cause any such battery cell to fail or vent gases. The thermally-conductive material may also distribute heat to the nearby cooling tubes and coolant contained therein.

In one embodiment, the potting compound or other thermally-conductive material 116 is poured into the spaces between the battery cells 108 in liquid form, which hardens to a solid or semi-solid material. Although solid materials such as hardening potting compounds can prevent leakage, potting compounds that remain somewhat liquid may be used. The potting compound or other thermally-conductive material 116 contacts the case of each battery cell as well as any nearby battery cells so that heat released from one battery cell due to physical (e.g. crushing), chemical or other causes will be rapidly transferred to many nearby battery cells as well as the potting compound itself and the substrate with which it is in contact. The potting compound or other thermally-conductive material 116 may have electrically insulating qualities or may be conductive. However, in one embodiment, the potting compound is not used solely to conduct electricity, connections on the battery cells being separately provided instead, for example, using the method described in the related application.

A second one or more substrates are added to the top of the battery cell assembly, and conductors are sandwiched around the substrates as described in the related application.

FIG. 1B is a side view of two rows of the battery cells after the potting compound has hardened among the battery cells and the tubes. The potting compound 116 will conduct any heat from one battery cell 110 that is overheating to many more of the battery cells than would have occurred if no potting compound was used. Not only is the heat spread to the immediately adjacent battery cells 120, it is also spread to more distant battery cells 130, as well as being absorbed by the potting compound 116 itself and optionally substrate 112 before dissipating into the ambient air (as noted, the upper one or more substrates are not shown in the figure). This effect distributes the heat from the battery cell 110 experiencing the failure, among multiple battery cells 120, 130 and the potting compound or other thermally conductive material 116, reducing the heat that will be absorbed by any one battery cell, and thereby reducing the chance that a second battery cell will achieve a temperature sufficient to cause a thermal reaction (which would cause the second battery cell to fail), optionally to the point of venting gases, resulting from the release of heat of the first battery cell.

FIGS. 1C and 1D are side and top views illustrating battery cells in a thermally conductive material according to another embodiment of the present invention. Referring now to FIGS. 1C and 1D, in this embodiment, the thermally conductive material 150 is a solid, such as a sheet of aluminum or other thermally conductive material. Holes 154 in the sheet 152 are inserted over the battery cells 152 or the battery cells 152 are inserted into holes 154 in the sheet 150. A bushing 156 or another thermally-conductive material that can thermally couple the battery cells 152 to the sheet is inserted among them to thermally couple each of the battery cells 152 to the sheet 150. In the case that the sheet is electrically conductive, the bushing 156 can be made of thermally conductive, but electrically insulating material. In one embodiment, potting compound may be used as the bushing 156. The cooling tubes may be thermally coupled to the sheet 150.

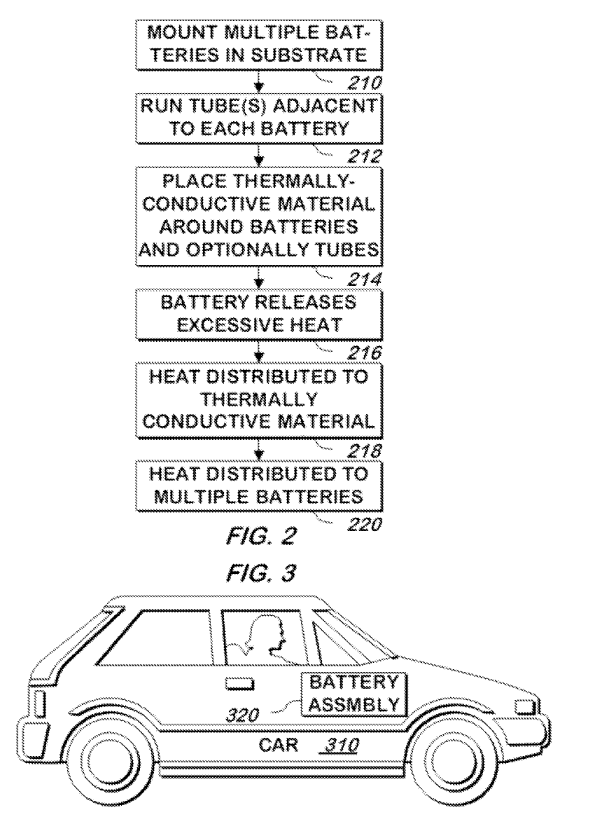

Referring now to FIG. 2, a method of manufacturing a chain-reaction-inhibiting battery cell pack and distributing heat generated from one battery cell to more than one other battery cell is shown according to one embodiment of the present invention. Multiple battery cells are mounted 210 in a substrate. One or more tubes containing a coolant such as water, are run 212 adjacent to each battery cell. In one embodiment, the coolant in the tubes runs in both directions past the battery cells, so that the coolant flows between the battery cells, turns around, and then flows out from between the battery cells in a counter-flow manner as described in the related application. Thermally conductive material such as potting compound is placed 214 in between the battery cells and may contact the tubes and optionally fully or partially hardens or becomes harder among the battery cells and the tubes, contacting the battery cells and the tubes. In the event of a reaction in which heat is generated from one of the battery cells and excess heat is released, for example, via a venting of heat and gases from one or more battery cells 216, such as could be caused by an internal short or a random thermal reaction starting in one or more of the battery cells, the thermally conductive potting compound will draw 218 the heat released from the battery cell to a wide area, wider than would have been likely if no potting compound was used, and will distribute 220 the heat to several of the battery cells, spreading the heat among more battery cells than would have occurred without the potting compound, and reducing the chance that the temperature of any of the adjacent battery cells immediately after the original release of heat will rise sufficiently to cause any such other battery cell to thermally react to the point of full or partial failure, such as by venting heat and gases. Step 218 may include a phase change of at least some of the material in the potting compound as described above.

Referring now to FIG. 3, a conventional vehicle 410 such as an electric-, hybrid-, or plug-in hybrid-powered car is shown according to one embodiment of the present invention. The battery cell assembly 320 produced as described above may be added to a conventional fully-, or partially-electric powered vehicle 310, such as an electric, hybrid or plug-in hybrid car or rocket. The battery cell assembly may be coupled to, and supply power to, an electric motor (not shown) powering the vehicle.

One or more battery cell assemblies according to the present invention may be used to build a conventional uninterruptible power supply, or other battery back-up device, such as that which may be used for data center power, cell-tower power, wind power back up or other backup power. One or more battery cell assemblies may be used to build hybrid power vehicles or equipment, electrical peak shaving equipment, voltage stability and/or regulation equipment or other equipment.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A battery pack, comprising:
a plurality of cells arranged into at least a first row of cells and a second row of cells, wherein said first row of cells is adjacent to said second row of cells, wherein said first row of cells is offset from said second row of cells, and wherein each of said plurality of cells includes a cell case;
at least one cooling tube containing a liquid coolant, said at least one cooling tube interposed between said first and second rows of cells; and
a thermally conductive material at least partially surrounding and contacting each cell case of said plurality of cells, wherein said thermally conductive material contacts said at least one cooling tube, and wherein said thermally conductive material is more thermally conductive than air.

2. The battery pack of claim 1, said at least one cooling tube comprised of a first cooling tube and a second cooling tube, wherein said liquid coolant flows through said first cooling tube past each cell of said plurality of cells in a first direction and said liquid coolant flows through said second cooling tube past each cell of said plurality of cells in a second direction, wherein said first direction is opposite said second direction.

3. The battery pack of claim 1, wherein each of said plurality of cells is cylindrically shaped.

4. The battery pack of claim 1, wherein said thermally conductive material surrounds and contacts between 5% and 30% of the height of each cell of said plurality of cells.

5. The battery pack of claim 1, wherein said thermally conductive material initially comprises a liquid that is poured around said plurality of cells and over said at least one cooling tube, wherein said thermally conductive material solidifies after application to said plurality of cells and said at least one cooling tube.

6. The battery pack of claim 5, wherein said thermally conductive material solidifies to a semi-solid state after application to said plurality of cells and said at least one cooling tube.

7. The battery pack of claim 1, wherein said thermally conductive material is comprised of a potting compound.

8. The battery pack of claim 1, wherein when one cell of said plurality of cells enters into thermal runaway, at least a portion of the thermally conductive material surrounding and contacting said one cell of said plurality of cells changes phase from a solid phase to a liquid phase.

9. The battery pack of claim 1, wherein said thermally conductive material is electrically insulating.

10. The battery pack of claim 1, wherein each cell of said plurality of cells has a cell width, and wherein each cell is positioned not more than half of the width from an adjacent cell of said plurality of cells.

11. The battery pack of claim 1, wherein each cell of said plurality of cells has a cell diameter, and wherein a center-to-center distance between adjacent cells of said plurality of cells is equal to or less than twice said cell diameter.

12. A method of dispersing heat from a thermal event occurring within at least one cell of a plurality of cells, said method comprising the steps of:
surrounding and contacting at least a portion of a cell case corresponding to each cell of said plurality of cells with a thermally conductive material, wherein said thermally conductive material is more thermally conductive than air;
contacting at least one cooling tube containing a liquid coolant with said thermally conductive material; and
pumping said liquid coolant through said at least one cooling tube, wherein said heat from said thermal event is transferred via said thermally conductive material to cells adjacent to said at least one cell of said plurality of cells, and wherein said heat from said thermal event is transferred via said thermally conductive material and said at least one cooling tube to said liquid coolant.

13. The method of claim 12, further comprising the steps of:
arranging said plurality of cells into at least a first row of cells and a second row of cells, wherein said first row of cells is adjacent to said second row of cells, and wherein said first row of cells is offset from said second row of cells; and
positioning said at least one cooling tube between said first and second rows of cells.

14. The method of claim 13, wherein the step of positioning said at least one cooling tube further comprises the step of positioning at least a first cooling tube and a second cooling tube between said first and second rows of cells, and wherein the step of pumping said liquid coolant through said at least one cooling tube further comprises the steps of pumping said liquid coolant through said first cooling tube in a first direction and pumping said liquid coolant through said second cooling tube in a second direction, wherein said first direction is opposite said second direction.

15. The method of claim 12, wherein said step of surrounding and contacting each cell of said plurality of cells with said thermally conductive material further comprises the step of surrounding and contacting between 5% and 30% of said cell case of each cell of said plurality of cells.

16. The method of claim 12, wherein said step of surrounding and contacting each cell of said plurality of cells with said thermally conductive material further comprises the step of pouring said thermally conductive material around each cell of said plurality of cells and said at least one cooling tube, wherein said thermally conductive material is liquid during said pouring step and then solidifies.

17. The method of claim 12, further comprising the step of selecting an electrically insulating material for said thermally conductive material.

18. The method of claim 12, further comprising the step of at least a portion of said thermally conductive material changing phase from a solid phase to a liquid phase during said thermal event.

19. The method of claim 12, wherein each cell has a width, and wherein said method further comprises the step of positioning each cell of said plurality of cells not more than half the width from an adjacent cell of said plurality of cells.

20. The method of claim 12, wherein each cell has a cell diameter, and wherein said method further comprises the step of positioning each cell of said plurality of cells such that a center-to-center distance between adjacent cells of said plurality of cells is equal to or less than twice said cell diameter.
